(19) United States
(12) Patent Application Publication
(10) Pub. No.: US 2026/0204907 A1
(43) Pub. Date: Jul. 16, 2026

(54) MITIGATING QUALITY FLUCTUATIONS DUE TO INSTABILITY OF RENEWABLE ENERGY SOURCES

(71) Applicant: ELECTRICAL GRID MONITORING LTD., ROSH HAAYIN (IL)

(72) Inventors: Yaakov YAHAV, NETANYA (IL); Nimrod SANDLERMAN, RAMAT GAN (IL)

(21) Appl. No.: 19/133,262

(22) PCT Filed: Dec. 6, 2023
(86) PCT No.: PCT/IB2023/062321

§ 371 Date: May 28, 2025

Related U.S. Application Data
(60) Provisional application No. 63/432,065, filed on Dec. 13, 2022.

(51) Int. Cl. H02J 3/0014; H02J 3/00; H02J 3/28; H02J 3/38; H02J 3/466; H02J 13/12; H02J 13/183; H02J 101/24; H02J 103/35; H02J 103/50

(52) U.S. Cl. CPC H02J 3/0014; H02J 3/004; H02J 3/28; H02J 3/381; H02J 3/466; H02J 13/12; H02J 13/183; H02J 2101/24; H02J 2103/35; H02J 2103/50

(57) ABSTRACT

Mitigating excessive quality fluctuations of the power in a power grid due to instability of renewable energy sources, by collecting electric production data including power capacity of an electric grid, location of one or more photovoltaic electric generation unit connected to the electric grid, and electric power generation by the photovoltaic electric generation units, receiving a weather prediction including one or more location, thickness, direction of motion, and speed of motion, of one or more cloud, computing location, direction of motion, speed of motion, and irradiation for cloud shadows, computing cloud shadow impact and time of impact on photovoltaic electric generation units, and, performing, before the cloud shadow reaches the photovoltaic electric generation unit, actions such as reducing power generation capacity of photovoltaic electric generation unit, increasing power input of power-generating-unit or an electric storage unit, and connecting or disconnecting reactance to the grid.

### FIELD

The method and apparatus disclosed herein are related to the field of electric grid, and, more particularly but not exclusively, to electric distribution networks and, more particularly but not exclusively, to managing the effects of production instability of renewable energy sources in a distribution network.

### BACKGROUND

Renewable energy sources are integrated into the grid in growing number and size. The renewable energy sources are usually integrated into the medium-voltage part of the distribution grid, and therefore, the electric power provided by each renewable energy system becomes an important part of the total power of the particular distribution grid. The energy production of popular types of renewable energy sources such as wind turbines and solar systems is not stable, due to sharp changes in the local wind speed, or local solar irradiation. When such instantaneous change of power production is introduced to the particular distribution grid, the power quality, or voltage quality, may decrease below the standard's requirements. In other words, the voltage level may drop below the limit set by the relevant standard, or the voltage immediate change can be sharper than the threshold that is set or approved by the local distribution system operator. It would therefore be highly advantageous to have a method and a system, devoid of the above limitations, for mitigating the effects of instability of renewable energy sources.

### SUMMARY

According to one exemplary embodiment there is provided a system, a method, and/or a computer program for mitigating excessive quality fluctuations of the power in a power grid due to instability of renewable energy sources, the method, system, and/or computer program including automatically collecting, by a local computer, electric production data including power capacity of an electric grid, location of one or more photovoltaic electric generation unit connected to the electric grid, and electric power generation by the one or more photovoltaic electric generation unit. Automatically receiving, by the local computer, from a computer of one or more weather stations, a weather prediction including one or more location, thickness, direction of motion, and speed of motion, of one or more cloud. Computing one or more location, direction of motion, speed of motion, and irradiation for one or more cloud shadows. Computing one or more cloud shadow impact and time of impact on one or more photovoltaic electric generation units. And, performing, before the cloud shadow reaches the photovoltaic electric generation unit, one or more actions from the list of actions including: Reducing power generation capacity of the one or more photovoltaic electric generation unit. Increasing power input of one or more power-generating-units. Providing electric power from an electric storage unit. Connecting capacitance to the grid. disconnecting capacitance from the grid. Connecting inductance to the grid. And disconnecting inductance from the grid.

According to another computer-implemented method for mitigating fluctuations of power quality in an electric grid, the method includes: determining a configuration of a part of the electric grid, the configuration including one or more power generating unit, one or more power consumer, and the electric grid interconnecting between the one or more power-generating-unit and the one or more power-consumer. Distributing a plurality of measuring devices within the electric grid interconnecting between the one or more power generating unit power generating unit and the one or more power generating unit power consumer. Automatically and continuously collecting power input values for one or more power input, by the respective one or more power-generating-unit, into the part of the electric grid. Automatically and continuously collecting a plurality of power transmission values from the respective plurality of measuring devices. Automatically and continuously collecting weather forecasts for a predetermined future timeframe, the weather forecasts being applicative to respective one or more power generating unit providing respective power input into the part of the electric grid. Automatically and continuously determining anticipated effect of each weather forecast on each power input and each measuring device to determine one or more weather-affected power-generating-unit. And, if the anticipated effect exceeds a predetermined threshold perform one or more actions such as: Reducing power generation capacity of the one or more photovoltaic electric generation unit. Increasing power input of one or more power-generating-units. Providing electric power from an electric storage unit. Connecting or disconnecting reactance to the grid.

According to yet another computer-implemented method for mitigating fluctuations of power quality in an electric grid, the method includes: Distributing a plurality of cable measuring devices, wherein each cable measuring device is mounted on a cable of the electric grid, wherein each of the cable measuring devices is capable of measuring one or more: voltage of the cable, current through the cable, solar irradiation, wind direction, and wind speed. Automatically collecting, by a local computer, electric production data including power capacity of an electric grid, location of one or more photovoltaic electric generation unit connected to the electric grid, and electric power generation by the one or more photovoltaic electric generation unit. Receiving from one or more of the cable measuring devices the one or more measurement. Computing one or more location, direction of motion, speed of motion, and irradiation for one or more cloud shadow. Computing one or more cloud shadow impact and time of impact on one or more photovoltaic electric generation unit. Performing, before the cloud shadow reaches the photovoltaic electric generation unit, one or more actions such as: Reducing power generation capacity of the one or more photovoltaic electric generation unit. Increasing power input of one or more power-generating-units. Providing electric power from an electric storage unit. Connecting or disconnecting reactance to the grid.

Further according to another exemplary embodiment, the method further includes Distributing a plurality of cable measuring devices, wherein each cable measuring device is mounted on a cable of the electric grid, wherein each of the cable measuring devices is capable of measuring one or more: voltage of the cable, current through the cable, solar irradiation, wind direction, and wind speed. Receiving from one or more of the cable measuring devices the one or more measurement. And, computing one or more location, direction of motion, speed of motion, and irradiation for one or more cloud shadow.

Still further, according to another exemplary embodiment, the impact is calculated according to one or more: voltage quality, power quality, change of voltage quality, change of power quality, and a predetermined threshold value.

Yet further, according to another exemplary embodiment, the method further includes one or more of the following: The power transmission value includes power quality value measured by one or more measuring device of the plurality of measuring devices. The impact includes power quality value measured by one or more measuring devices of the plurality of measuring devices. The power transmission value includes voltage quality value measured by one or more measuring device of the plurality of measuring devices. The impact includes voltage quality value measured by one or more measuring devices of the plurality of measuring devices. And the voltage quality includes anticipated deviation of voltage measurement value from a standard voltage value.

Unless otherwise defined, all technical and scientific terms used herein have the same meaning as commonly understood by one of ordinary skill in the relevant art. The materials, methods, and examples provided herein are illustrative only and not intended to be limiting. Except to the extent necessary or inherent in the processes themselves, no particular order to steps or stages of methods and processes described in this disclosure, including the figures, is intended or implied. In many cases the order of process steps may vary without changing the purpose or effect of the methods described.

### BRIEF DESCRIPTION OF THE DRAWINGS

Various embodiments are described herein, by way of example only, with reference to the accompanying drawings. With specific reference now to the drawings in detail, it is stressed that the particulars shown are by way of example and for purposes of illustrative discussion of the preferred embodiments only, and are presented in order to provide what is believed to be the most useful and readily understood description of the principles and conceptual aspects of the embodiment.

In this regard, no attempt is made to show structural details of the embodiments in more detail than is necessary for a fundamental understanding of the subject matter, the description taken with the drawings making apparent to those skilled in the art how the several forms and structures may be embodied in practice.

### In the Drawings:

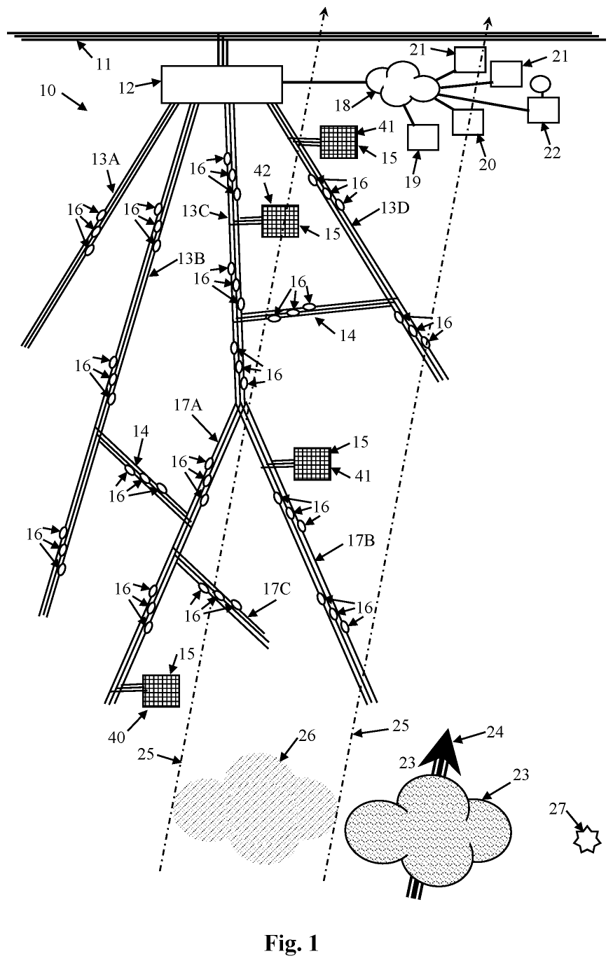

FIG. 1 is a simplified illustration of a distribution grid, connected to a transmission grid, via a transformer station, and monitored by a grid analysis system;

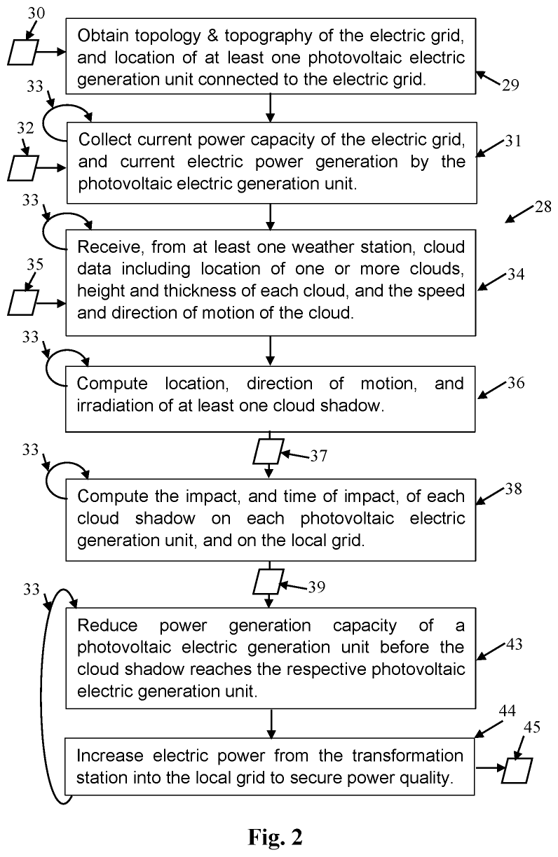

FIG. 2 is a simplified flow chart of a first basic computing process executed by the grid analysis system;

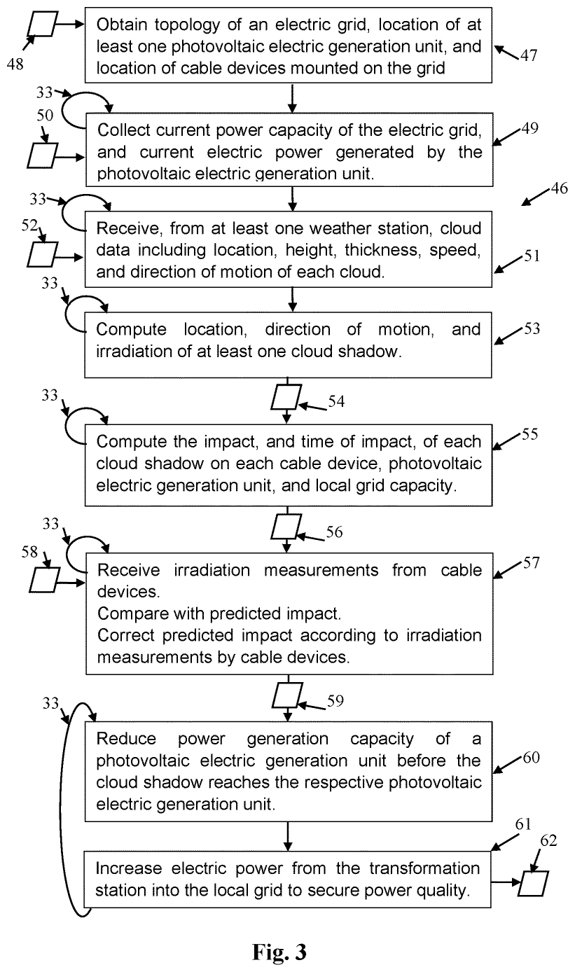

FIG. 3 is a simplified flow chart of a second, alternative, basic computing process executed by the grid analysis system;

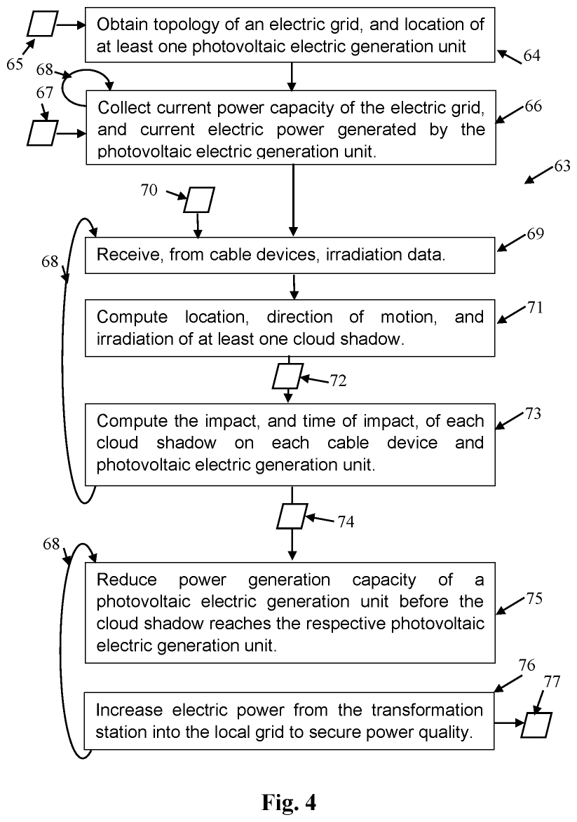

FIG. 4 is a simplified flow chart of a third, alternative, basic computing process executed by the grid analysis system;

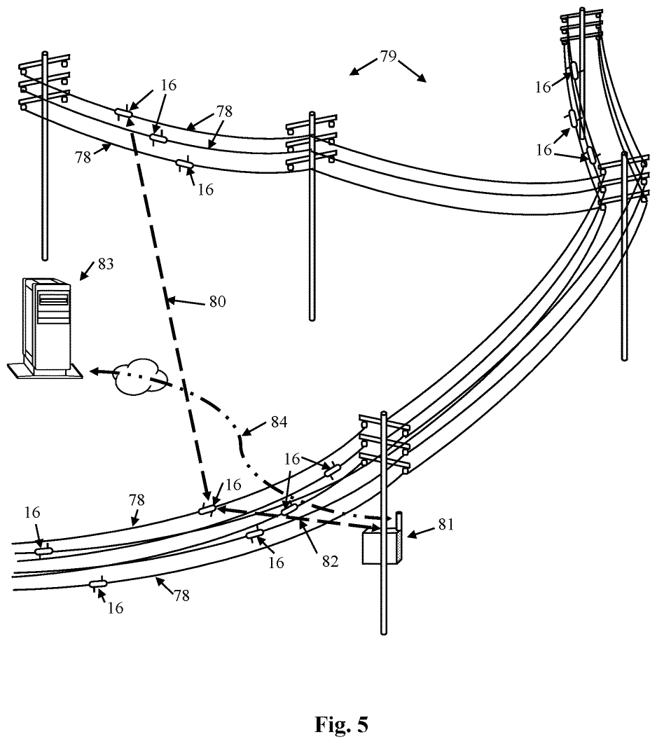

FIG. 5 is a simplified illustration of a plurality of cable devices mounted on respective electric cables of an electric grid and a fault detection and location system including some of the cable devices;

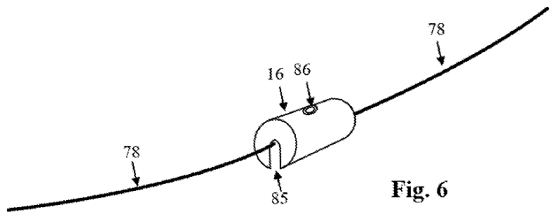

FIG. 6 is a simplified illustration of cable device mounted on an electric cable showing a slot for inserting the cable into the cable device, and an irradiation measuring unit included in cable device;

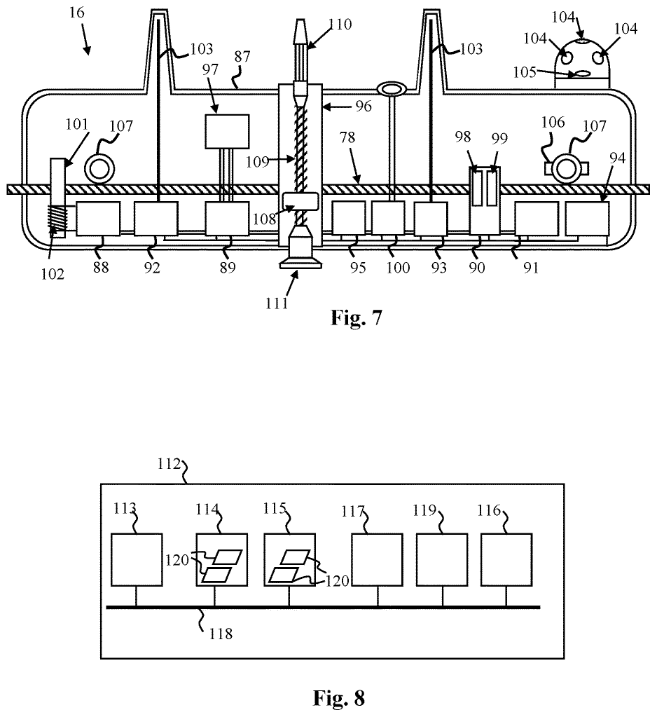

FIG. 7 is a simplified illustration of a cut through a cable device mounted on an electric cable and including the voltage measuring system; and

FIG. 8 is a simplified illustration of a computational device as may be used by a cable device or a grid analysis system.

### DESCRIPTION OF EMBODIMENTS

The present embodiments comprise a system, a method, and/or a computer program for mitigating excessive quality fluctuations of the electric power provided by an electric grid where the fluctuations are caused by the typical instability of renewable energy sources being part of the grid. Particularly, the fluctuations are caused by changing weather conditions affecting the production of electric power by respective renewable energy sources such as solar systems and wind turbines.

The principles and operation of the system, the method, and/or the computer program for mitigating weather effects on the power quality provided by an electric grid according to the several exemplary embodiments may be better understood with reference to the following drawings and accompanying description.

Before explaining at least one embodiment in detail, it is to be understood that the embodiments are not limited in its application to the details of construction and the arrangement of the components set forth in the following description or illustrated in the drawings. Other embodiments may be practiced or carried out in various ways. Also, it is to be understood that the phraseology and terminology employed herein is for the purpose of description and should not be regarded as limiting.

In this document, an element of a drawing that is not described within the scope of the drawing and is labeled with a numeral that has been described in a previous drawing has the same use and description as in the previous drawings. Similarly, an element that is identified in the text by a numeral that does not appear in the drawing described by the text, has the same use and description as in the previous drawings where it was described.

The drawings in this document are not meant to be in any scale. Different FIGURES may use different scales and different scales can be used even within the same drawing. For example, different scales for different views of the same object or different scales for two adjacent objects.

The phrases “at least one” “one or more” and “and/or” are open-ended expressions that are both conjunctive and disjunctive in operation. For example, each of the expressions “at least one of A, B and C, “at least one of A, B, or C, “one or more of A, B, and C. “one or more of A, B, or C and “A, B, and/or C” means A alone, B alone, C alone, A and B together, A and C together, B and C together, or A, B and C together. The terms “a” or “an entity” refers to one or more of that entity. As such, the terms “a” (or “an”), “one or more” and “at least one” can be used interchangeably herein.

It is also to be noted that the terms ‘comprising’, ‘including’, ‘containing’, ‘characterized by’, and ‘having’ are all inclusive, open-ended, does not exclude additional, unrecited elements or method steps, and can be used interchangeably.

Reference throughout this specification to “one embodiment,” “an embodiment,” or similar language means that a particular feature, structure, or characteristic that is described in connection with the embodiment is included in at least one embodiment of the present disclosure. Thus, appearances of the phrases “in one embodiment,” “in an embodiment, and similar language throughout this specification may, but do not necessarily, all refer to the same embodiment.

The term plurality, as used herein, is defined as two or more than two. The term another, as used herein, is defined as at least a second or more. The term coupled, as used herein, is defined as connected, although not necessarily directly, and not necessarily mechanically.

In this document, the term ‘computing device’ may refer to any type of computing machine, including but not limited to, a computer, a portable computer, a laptop computer, a tablet computer, a mobile communication device, a network server, a cloud computer, etc., as well as any combination thereof. Such computing device or computing machine may include any type or combination of devices, including, but not limited to, a processor or a processing device, a memory device, a storage device, a user interface device, and/or a communication device.

The terms ‘execute’, ‘perform’, compute, calculate, etc. may refer to a processor of a computational device executing a software program code embodied on a non-transitory computer readable medium to achieve a result such as described after any of the terms ‘execute’, ‘perform’, compute, calculate, etc.

The term ‘client computing device’, or ‘client device’, ‘user device’ may refer to any type of computing device that is directly used, or operated, by a user. Such device may include a user interface that may be used by a user directly, including means for user input and/or user output. Such device may be communicatively coupled to another computing devices such as a network server via a communication network.

Means for user input may include a keyboard, a pointing devices such as a mouse, a microphone, a camera, a touch-sensitive plate or display, means for user gesture control, means for haptic user control, etc.

Means for user output may include a display, and/or any other means for providing visual information, a speaker, or an earphone, and/or any other means for providing audible information, means for providing tactile and/or haptic information, etc.

The term ‘mobile communication device” may refer to devices such as a tablet, a mobile telephone, a smartphone, etc.

The term ‘network server’ or ‘server’ may refer to any type of ‘computing device’ that is communicatively coupled to a communication network and may include a cloud computer, etc.

The term ‘communication network’ or ‘network’ may refer to any type or technology for digital communication including, but not limited to, the Internet, WAN, LAN, MAN, PSDN, etc. Any of the abovementioned technologies may be wired or wireless, for example, Wireless WAN such as WiMAX, WLAN (Wi-Fi), WPAN (Bluetooth), etc. Wireless networking technology may also include PLMN, and/or any type of cellular network. The term ‘communication network’ or ‘network’ may refer to any combination of communication technologies, and to any combination of physical networks. The term ‘communication network’ or ‘network’ may refer to any number of interconnected communication networks that may be operated by one or many network operators.

The term ‘application’ may refer to a software program running on, or executed by, one or more processors of a computing devices, and particularly by a mobile computing device such as a mobile telephone, a tablet, a smartphone, etc., as well as any other mobile or portable computing facility. The term ‘mobile application’ may refer to an application executed by a mobile computing device.

In this document the terms ‘electric transmission network’, ‘electrical transmission network’, ‘electricity transmission network’, ‘electric power transmission’, ‘power line’, ‘power transmission’ and ‘power grid’ can be used interchangeably and relate to either or both underground and overhead transmission. The terms ‘grid’, or ‘electric grid’, or ‘electric network’ may refer to the electric transmission network and/or the electric distribution network, and to any part of such network between the power generating station, or stations, and the load, or the consumer(s).

The term ‘cable’, or ‘electric cable’, may refer to any single cable, or wire, or powerline, of the grid, such as a phase carrying cable. The term ‘cable device’, or ‘measuring device’, or ‘sensor’ may refer to any device mounted on an electric cable of a grid, including a sensor, a measuring device, a communication device, etc. As a non-limiting example, the cable device may derive power from the electric field and/or magnetic field around the electric cable, where the electric and/or magnetic field may be generated by the electric current flowing in the electric cable.

The term ‘measurement’ or ‘electrical measurement’ may refer to any type of measurement of any electric parameter such as voltage, current, electric field, magnetic field, resistance, capacitance, inductance, electric charge, etc. The term ‘physical measurement’ or ‘mechanical measurement’ may refer to any type of measurement of any physical parameter other than electrical parameters. Such parameters may be temperature, wind (including speed and/or direction), humidity, motion, height, (cable) depression, (cable) angle, etc. Such measurements are typically performed by a cable device mounted on an electric cable.

The system of measuring devices may measure various electric parameters in a plurality of locations in an electric cable, or an electric network, or an electric grid, and determine, by comparing a plurality of measurements, the type and location of a particular parameter, and/or phenomenon, and/or fault. Such measurement may be taken at a point of the electric cable which may be in mid cable, which is at a distance from any pole or insulator supporting the cable. In such point the measuring device may not have any electric contact with a reference point such as ground, or zero or neutral, or common line, etc.

In this respect, the voltage measuring device may be electrically coupled to the electric cable as a first reference point for measuring potential difference (e.g., voltage), but may lack a second electric contact to a second reference point (namely, neutral, ground, common line, etc.)

The term ‘mid cable’ may refer to any position or point along the electric cable in which the cable device, or sensor, or measuring device, may be mounted on the electric cable, and where the cable device, or sensor, or measuring device, may not have access or electric contact to a reference electric potential such as ground, zero line, common like, neutral line, etc.

The term ‘reference point’ may refer to any such reference electric potential such as ground, zero line, common like, neutral line, a powerline of a different phase, a reference plane, etc.

The term ‘electrically coupled’, or ‘electrically connected’, or simply ‘connected’ may refer to direct (e.g., galvanic contact) or indirect electric contact.

The term ‘ungrounded voltage measurement’ may refer to measuring electric voltage, or electric potential, of an electric element, such as an electric cable, being a first electric reference point, without contacting a second electric reference point, such as reference point, zero voltage line, common line, neutral line, a power line of a different phase, etc. For simplicity, all such versions of the second electric reference point may be referred herein as ‘reference point’.

The terms ‘intermittent’ or ‘instantaneous’ may refer to any electric phenomenon that is short, typically below one second. In this respect, ‘intermittent phenomenon’ may refer to any type of short-time or instantaneous change of voltage and/or current and/or power. Such ‘intermittent phenomenon’ may take the form of a surge (positive, or negative, or both), a pulse (positive, or negative, or both), a transient, a spike, etc.

The term ‘absolute time’ may refer to the time-of-day or a length of time measured from a common universal time. Absolute time may be provided via a signal from an external accurate clock such as a GPS (global positioning system) signal. The terms ‘time of flight’ or ‘time of travel’ may refer to the time it takes for a signal to travel from a first point to a second point, such as from a point of origin of the signal to a point of detection, or measurement.

The device measuring the electric signal may be an electric sensor operative to measure one or more electric parameters such as electric voltage and/or electric current. The measuring device may be mounted on the electric cable, anywhere over the electric cable, whether on or near a pole carrying the cable, or anywhere between two poles or between two insulators carrying or supporting the cable. The cable may be an overhead cable or an underground cable. For example, for an underground cable the measuring device may be placed in a location where the underground cable is exposed, and/or with no shield, such as in maintenance holes (manholes) or split points, etc.

Reference is now made to FIG. 1, which is a simplified illustration of a distribution grid 10, connected to a transmission grid 11, via a transformer station 12, according to one exemplary embodiment.

As shown in FIG. 1, The distribution grid 10 may include four feed lines 13, however, any number of feed lines is contemplated. The four feed lines are enumerated as 13A, 13B, 13C, and 13D. Two tie lines 14 may be connected between feed lines 13B-13C and between 13C-13D, though any number of tie lines is contemplated.

As shown in FIG. 1, one or more photovoltaic systems 15 may be connected to any one of feed lines 13. However, any system 15 may represent any type of renewable energy electricity generating system (e.g., wind turbine, etc.). A plurality of consumer systems (not shown in FIG. 1) may be distributed along of feed lines 13. A plurality of cable devices 16 may be mounted over any of the power lines of distribution grid 10. It is appreciated that any number of cable devices 16 may be mounted over any of the power lines (phases) of distribution grid 10.

As shown in FIG. 1, feed line 13A is split into two sub-lines 17A and 17B. It is appreciated that any feed line 13A may be split into any number of sublines in various forms and split levels (e.g., 17C). The term ‘local grid’ may refer to the entire grid 10 or to a distinct part of grid 10 such as a particular feed line 13, or a sub-line 17. The entire structure and/or topology of distribution grid 10 of FIG. 1 is provided as an example only.

Communication network 18 may represent any number of communication networks of any type including wireline and wireless networks. Communication network 18 may also represent several networks that are not inter-connected, where each network serves a different pair or group of computational devices capable of communicating.

For example, communication network 18 may interconnect between transformer station 12 and grid management system 19, between grid management system 19 and grid analysis system 20, between grid analysis system 20 and any number of weather stations 21. Weather stations 21 may provide weather measurement, weather analysis, weather forecast, etc. Weather stations 21 may include a cloud radar 22, lidar, visibility measurement units, irradiation measuring stations, etc. Communication network 18 may also interconnect between grid analysis system 20 and any number of cable devices 16. Communication network 18 may also interconnect between grid management system 19 and energy generation systems 15.

FIG. 1 also shows a cloud 23 blown by wind 24 in the direction of arrow 24 as may be measured and/or predicted by any of weather stations 21 and/or cloud radar 22, etc. Dotted lines 25 may indicate the boundaries of the effective shadow 26 as casted by cloud 23. The parameters of the effective shadow 26, in terms, for example, of location, area and irradiation, may depend on the current position of the sun 27, the thickness and structure of cloud 23, etc.

Reference is now made to FIG. 2, which is a simplified flow chart of a first basic computing process 28 executed, for example, by grid analysis system 20, according to one exemplary embodiment.

As an option, the simplified flow chart of FIG. 2 may be viewed in the context of the details of the previous FIGURES. Of course, however, the simplified flow chart of FIG. 2 may be viewed in the context of any desired environment. Further, the aforementioned definitions may equally apply to the description below.

It is appreciated that the flow chart of first basic computing process 28 may be embodied as one or more computer programs executed by one or more processors of analysis system 20. It is appreciated that some of the actions of first basic computing process 28 may be executed by grid management system 19.

First basic computing process 28 may start with action 29 by obtaining grid data 30. In this respect the term ‘grid data’ may include (but not limited to) topology and topography of a local electric grid. The term ‘local electric grid’ may refer, as a non-limiting example, to a distribution grid such as distribution grid 10 of FIG. 1, or any part thereof. Such ‘local grid’ may therefore include one or more feed lines 13, one or more sub-lines 17, etc. The term ‘topology’ may refer to the electric relations between elements of the distribution grid 10. The term ‘topography’ may refer to the geographical locations of the elements of the distribution grid 10. The term ‘elements of the distribution grid’ may refer to the grid itself as well as any other physical element and/or electrical device connected to the grid.

Action 29 may therefore also obtain the topographic and/or geographic locations of each photovoltaic electric generation unit connected to the electric grid and its maximum electric generation capacity. The term ‘obtain’ here may refer to introducing the grid data 30 to a computational device as computational data, either manually or automatically. Such computational device may be operated by, for example, grid analysis system 20 as well as grid management system 19. It is appreciated that action 29 may be repeated from time to time to obtain updates to the grid data.

First basic computing process 28 may then proceed to action 31 to collect grid electric data 32, for example in the form of the current power capacity of the electric grid, and the current electric power generated by each of the photovoltaic electric generation units. For example, the processor of grid analysis system 20, may execute action 31 by automatically collecting these data elements from grid management system 19.

As indicated by arrow 33, action 31 is a repetitive, or continuous, automated process. It is appreciated that the electric power carried by the local grid, and the electric power provided by the transformer station 12 to the local grid, as well as the electric power generated by the photovoltaic electric generation units connected to the local grid, may change momentarily. For example, because of changes in the electric consumption of the consumers connected to the local grid. Therefore requiring fast repletion of action 31.

First basic computing process 28 may then proceed to action 34 to receive weather data 35 from one or more weather stations such as weather stations 21 of FIG. 1. Such weather data may include cloud measurements such as may be performed by one or more cloud radars 22. Cloud measurements may include, for each cloud within the area that is relevant to the geographic spread of the electric grid (such as grid 10 of FIG. 1) location of the cloud, area of the cloud, height of the cloud, thickness of the cloud, speed and direction of motion of the cloud, etc.

In this respect the term ‘cloud height’ may refer to the distance between the base of the cloud and the ground below. In this respect the term ‘cloud thickness’ may refer to the distance between the top of the cloud and the base of the cloud. In this respect the term ‘cloud area’ may refer to the horizontal contour of the cloud provided as a function or as a collection of points along the contour, such as the X and Y values of the points.

First basic computing process 28 may then proceed to action 36 to compute cloud shadow data 37 from weather data 35. Cloud shadow data 37 may include the location and size of the cloud shadow, the speed and direction of motion of the cloud shadow, and the irradiation within the cloud shadow. Cloud shadow data 37 may be computed separately for each cloud within the area that is relevant to the geographic spread of the electric grid (such as grid 10 of FIG. 1). Cloud shadow data 37 may be computed according to the cloud data and the position of the sun. In this respect the term ‘shadow location and size’ may refer to the contour of the shadow as casted on the ground. The contour data may be provided as a function or as a collection of points along the contour, such as the X and Y values of the points.

First basic computing process 28 may then proceed to action 38 to compute a cloud impact data 39 for each cloud shadow on each photovoltaic electric generation unit. The cloud impact data 39 may include expected impact and expected time of impact. The term ‘impact’ may represent the absolute irradiation within the time of impact, or the irradiation decrease within the time of impact, or the expected power production of the photovoltaic electric generation unit within the time of impact. The term ‘time of impact’ may represent the expected start time and the expected end time or elapsed time that the cloud shadow may impact the photovoltaic electric generation unit. The impact may be calculated according to the expected solar irradiation and the thickness of the cloud. It is appreciated that the term impact may apply to the irradiation decrease when the cloud shadow hits the respective photovoltaic electric generation unit and to the irradiation increase, when the cloud shadow leaves the respective photovoltaic electric generation unit.

For example, the impact calculation may determine that a particular cloud shadow may entirely miss a particular photovoltaic electric generation unit, or that the particular cloud shadow may hit the particular photovoltaic electric generation unit, in a particular time for a particular period. The particular cloud shadow may cover all the area of the particular photovoltaic electric generation unit, or only a part of it. Thus, for example reducing the output power of the particular photovoltaic electric generation unit by a calculated percentage.

Returning to the exemplary grid 10 and cloud 23 of FIG. 1, it may be seen that shadow 26 misses the photovoltaic electric generation unit designated by numeral 40, hits the photovoltaic electric generation units designated by numeral 41, and partly hits the photovoltaic electric generation unit designated by numeral 42. The photovoltaic electric generation units designated by numerals 41 and 42, are affected in different times.

Consequently, action 38 may also compute the overall impact of the particular cloud shadow, when impacting the particular photovoltaic electric generation unit, on the power carried by the local grid. For example, action 38 may compute the maximum expected decrease of the voltage value provided by the local grid to the consumers, at the maximum impact of the particular cloud shadow, when impacting the particular photovoltaic electric generation unit. Action 38 may compute the maximum amount of power that should be added to the local grid at that point to replenish the power missing due to the above impact.

First basic computing process 28 may then proceed to action 43 and action 44 to reduce the power generated by the respective photovoltaic electric generation unit before the cloud shadow reaches the respective photovoltaic electric generation unit, and, preferably in parallel, to increase the electric power provided by other sources to the respective local grid. Thus, first basic computing process 28 may mitigate the anticipated effect of the cloud shadow on the power quality, or voltage quality, as experienced by the consumers connected to the respective local grid.

The term ‘other sources’ herein may refer to the transformation station 12 and/or any other photovoltaic electric generation unit(s) that may be connected to the local grid and may not be affected by the cloud shadow at the same time. The term ‘other sources’ may also refer to energy sources such as energy storage systems that may be connected to the local grid. The term ‘other sources’ may also refer to capacitance or inductance systems that may be connected to the local grid. In this respect, the phrase “increase the electric power provided by other sources to the respective local grid” may refer to increasing or decreasing the capacitance and/or inductance.

It is appreciated that the action of decreasing the power generated by the respective photovoltaic electric generation unit before the cloud shadow reaches the respective photovoltaic electric generation unit may depend on a predefined threshold, which may be associated, for example, with power quality and/or with voltage quality.

As a non-limiting example, if the standard requires that the voltage does not decrease by more than 3% below the standard level, action 43 may reduce the power provided by the respective photovoltaic electric generation unit(s) to be shortly affected by the proceeding cloud shadow below 3% of the total power provided by the local grid. In the case that the shadow causes the particular photovoltaic electric generation unit to stop power production entirely, the impact on the local grid will still be within the limits of the standard.

Alternatively, or additionally, first basic computing process 28 may increase the power provided to the local grid by the transformation station 12 and/or other photovoltaic electric generation unit that are not expected to be affected by the clod shadow at the same time. The action of increasing the power before the cloud shadow reaches the respective photovoltaic electric generation unit may also depend on a predefined threshold, which may be associated, for example, with power quality and/or with voltage quality.

As a non-limiting example, if the impact of the cloud on the particular photovoltaic electric generation unit may cause a power reduction of 50%, and the particular photovoltaic electric generation unit provides 10% of the total power carried by the local grid, action 43 may reduce the power output of the particular photovoltaic electric generation unit to below 6% of the total grid power, so that 50% reduction of the power provided by the particular photovoltaic electric generation unit may cause an impact smaller than 3% on the voltage level of the local grid.

Optionally, first basic computing process 28 may decrease the power of the respective photovoltaic electric generation unit(s) and increase the power provided by other resources by communicating instructions 45 to grid management system 19.

Arrows 33 may indicate that the respective action, or sequence of actions, may be repeated, and that the execution of the respective actions may be performed in parallel. In this sense, actions 31, action 34, action 36 and action 38 may be performed in parallel with each other and with the sequence of actions 43 and 44.

Reference is now made to FIG. 3, which is a simplified flow chart of a second basic computing process 46 executed, for example, by grid analysis system 20, according to one exemplary embodiment.

As an option, the simplified flow chart of FIG. 3 may be viewed in the context of the details of the previous FIGURES. Of course, however, the simplified flow chart of FIG. 3 may be viewed in the context of any desired environment. Further, the aforementioned definitions may equally apply to the description below.

It is appreciated that the flow chart of second basic computing process 46 may be embodied as one or more computer programs executed by one or more processors of analysis system 20. It is appreciated that some of the actions of second basic computing process 28 may be executed by grid management system 19.

Second basic computing process 46 is similar to first basic computing process 28, however adding a network of cable devices 16 to verify the anticipated cloud shadow motion and correct the forecast where necessary. It is appreciated that Second basic computing process 46 may be used as an alternative to first basic computing process 28.

As will be described below with further details, cable devices 16 may be equipped with various measuring devices, including voltage, current and irradiation sensors. Cable devices 16 may thus provide irradiation measurements, including but not limited to irradiation value, rate of change of irradiation, time of change of irradiation, etc.

Second basic computing process 46 may start with action 47 by obtaining grid data 48. In this respect the term ‘grid data’ may include (but not limited to) topology and topography of a local electric grid. The term ‘local electric grid’ may refer, as a non-limiting example, to a distribution grid such as distribution grid 10 of FIG. 1, or any part thereof. Such ‘local grid’ may therefore include one or more feed lines 13, one or more sub-lines 17, etc. The term ‘topology’ may refer to the electric relations between elements of the distribution grid 10. The term ‘topography’ may refer to the geographical locations of the elements of the distribution grid 10. The term ‘elements of the distribution grid’ may refer to the grid itself as well as any other physical element and/or electrical device connected to the grid including cable devices 16.

Action 47 may therefore also obtain the topographic (or geographic) location of each photovoltaic electric generation unit connected to the electric grid and its maximum electric generation capacity. Action 47 may also obtain the topographic (or geographic) location of each cable device mounted on the electric grid. The term ‘obtain’ here may refer to introducing the grid data to a computational device as computational data, either manually or automatically. Such computational device may be operated by, for example, grid analysis system 20 as well as grid management system 19. It is appreciated that action 29 may be repeated from time to time to obtain updates to the grid data.

Second basic computing process 46 may then proceed to action 49 to collect grid electric data 50, for example in the form of the current power capacity of the electric grid, and the current electric power generated by each of the photovoltaic electric generation units. For example, the processor of grid analysis system 20, may execute action 31 by automatically collecting these data elements from grid management system 19.

Alternatively, or additionally, action 49 may collect electric grid data 50 from cable devices 16, for example in the form of instantaneous, or averaged, voltage and current measurements. Thus, action 49 may develop a more detailed view of the current power distribution through the local grid.

Action 49 is a repetitive, or continuous, automated process because the electric power carried by the local grid, and the electric power provided by the transformer station 12 to the local grid, as well as the electric power generated by the photovoltaic electric generation units connected to the local grid, may change momentarily, for example, because of changes in the electric consumption of the consumers connected to the local grid.

Second basic computing process 46 may then proceed to action 51 to receive weather data 52 from one or more weather stations such as weather stations 21 of FIG. 1. Such weather data may include cloud measurements such as may be performed by one or more cloud radars 22. Cloud measurements may include, for each cloud within the area that is relevant to the geographic spread of the electric grid (such as grid 10 of FIG. 1) location of the cloud, area of the cloud, height of the cloud, thickness of the cloud, speed and direction of motion of the cloud, etc.

Second basic computing process 46 may then proceed to action 53 to compute cloud shadow data 54 from weather data 52. Cloud shadow data 54 may include the location and size of the cloud shadow, the speed and direction of motion of the cloud shadow, and the irradiation within the cloud shadow. Cloud shadow data 37 may be computed separately for each cloud within the area that is relevant to the geographic spread of the electric grid (such as grid 10 of FIG. 1). Cloud shadow data 37 may be computed according to the cloud data and the position of the sun. In this respect the term ‘shadow location and size’ may refer to the contour of the shadow as casted on the ground. The contour data may be provided as a function or as a collection of points along the contour, such as the X and Y values of the points.

Second basic computing process 46 may then proceed to action 55 to compute a cloud impact data 56 for each cloud shadow on each photovoltaic electric generation unit as well as each cable device 16. The cloud impact data 56 may include expected impact and expected time of impact. The term ‘impact’ may represent the absolute irradiation within the time of impact, or the irradiation change within the time of impact, or the expected power production of the photovoltaic electric generation unit within the time of impact. The term ‘time of impact’ may represent the expected start time and the expected end time or elapsed time that the cloud shadow may impact the photovoltaic electric generation unit. The impact, and/or the irradiation change, may be calculated according to the expected solar irradiation and the thickness of the cloud. It is appreciated that the term impact may apply to the irradiation decrease when the cloud shadow hits the respective grid element, and to the irradiation increase when the cloud shadow leaves the respective grid element. On this regard the term ‘grid element’ may also include any cable device 16.

Consequently, action 55 may also compute the overall impact of the particular cloud shadow, when impacting a particular photovoltaic electric generation unit. The term ‘overall impact’ may refer to the overall power carried by the local grid. For example, action 55 may compute the maximum expected decrease of the voltage value provided by the local grid to the consumers, at the maximum impact of the particular cloud shadow, when impacting the particular photovoltaic electric generation unit. Action 55 may compute the maximum amount of power that should be added to the local grid at that point to replenish the power missing due to the above impact.

Second basic computing process 46 may then proceed to action 57 to receive irradiation measurements 58 from one or more cable devices 16. Particularly, from cable devices 16 currently impacted by a particular cloud shadow. Action 57 may then compare the forecasted cloud impact data 56 with the current, actual, irradiation measurements 58. Consequently, action 57 may produce updated and/or corrected forecasted cloud impact data 59.

It is appreciated that each cable device 16 may provide irradiation data of a sunny and a shadow zone, as well as wind speed measurement and measurement of wind direction. Each cable device 16 may also provide power transmission value and power quality value, voltage value and voltage quality value, and the value of the current through the respective cable. Each cable device 16 may also calculate the anticipated effect and power quality value and/or voltage quality value and/or change of value due to recent change if irradiation value,

Second basic computing process 46 may then proceed to action 60 and action 61 to reduce the power generated by the respective photovoltaic electric generation unit before the cloud shadow reaches the respective photovoltaic electric generation unit, and, preferably in parallel, to increase the electric power provided by other sources to the respective local grid. Thus, second basic computing process 46 may mitigate the anticipated effect of the cloud shadow on the power quality, or voltage quality, as experienced by the consumers connected to the respective local grid.

The term ‘other sources’ may refer to the transformation station 12 and/or any other photovoltaic electric generation unit(s) that may be connected to the local grid and may not be affected by the cloud shadow at the same time. The term ‘other sources’ may also refer to energy sources such as energy storage systems that may be connected to the local grid. The term ‘other sources’ may also refer to capacitance or inductance systems that may be connected to the local grid. In this respect, the phrase “increase the electric power provided by other sources to the respective local grid” may refer to increasing or decreasing the capacitance and/or inductance.

The actions of increasing power and/or decreasing power (actions 60 and 61) may depend on respective thresholds, which may be associated with power quality and/or with voltage quality, in a similar manner like the examples provided with reference to actions 43 and 44 of the first basic computing process 28.

Arrows 33 may indicate that the respective action, or sequence of actions, may be repeated, and that the execution of the respective actions may be performed in parallel. In this sense, action 49, action 51, action 53, action 55 and action 57 may be performed in parallel with each other and with the sequence of actions 60 and 61.

Optionally, second basic computing process 46 may communicate instructions 62 to grid management system 19 to decrease the power of the respective photovoltaic electric generation unit(s) and increase the power provided by other resources by before the cloud shadow impact on each particular photovoltaic electric generation unit. Similarly, second basic computing process 46 may communicate instructions 62 to grid management system 19 to increase the power of the respective photovoltaic electric generation unit(s) and decrease the power provided by other resources before the cloud shadow impact on each particular photovoltaic electric generation unit ends.

Reference is now made to FIG. 4, which is a simplified flow chart of a third basic process 63 for mitigating power fluctuations in an electric grid, according to one exemplary embodiment.

As an option, the simplified illustration of FIG. 4 may be viewed in the context of the details of the previous FIGURES. Of course, however, the simplified illustration of FIG. 4 may be viewed in the context of any desired environment. Further, the aforementioned definitions may equally apply to the description below.

It is appreciated that the flow chart of third basic computing process 63 may be embodied as one or more computer programs executed by one or more processors of analysis system 20. It is appreciated that some of the actions of second basic computing process 28 may be executed by grid management system 19.

Third basic computing process 63 is similar to first basic computing process 28, however a network of cable devices 16 is used instead of weather stations to anticipate cloud shadow motion. It is appreciated that third basic computing process 46 may be used as an alternative to first and second basic computing processes if weather data is not available.

Third basic computing process 63 may start with action 64 by obtaining grid data 65 similar to second basic computing process 46. Third basic computing process 63 may then proceed to action 66 to collect grid electric data 67 similar to second basic computing process 46. Action 66 may be executed continuously, or repeatedly, as necessary, as indicated by arrow 68.

Third basic computing process 63 may then proceed to action 69 to collect irradiation data 70 from cable devices 16, and then to action 71 to compute a map 72 of shadow patches according to the irradiation data 70. Action 71 may also compute the direction of motion, the speed of motion and the irradiation value for each of the shadow patches. Third basic computing process 63 may then proceed to action 73 to compute the forecasted impact 74 of each shadow patch on each cable device 16 and each photovoltaic electric generation unit 15.

Third basic computing process 63 may execute actions 69, 71, and 73 continuously, or repeatedly, as necessary, to improve the mapping of the shadow patches, their assumed boundaries, the speed and direction of motion, as well as the anticipated irradiation. Therefore, impact data 74 may be regarded as a stream of data forecasting the irradiation change for each element of the local grid.

Third basic computing process 63 may then proceed to action 75 and action 76 to reduce the power generated by the respective photovoltaic electric generation unit before the respective shadow patch reaches the respective photovoltaic electric generation unit, and, preferably in parallel, to increase the electric power provided by other sources to the respective local grid. Thus, third basic computing process 63 may mitigate the anticipated effect of the cloud shadow on the power quality, or voltage quality, as experienced by the consumers connected to the respective local grid. For example, third basic computing process 63 may reduce or increase electric power by communicating instructions 77 to grid management system 19.

The actions of increasing power and/or decreasing power (actions 75 and 76) may depend on respective thresholds, which may be associated with power quality and/or with voltage quality, in a similar manner like the examples provided with reference to actions 43 and 44 of the first basic computing process 28.

Arrows 68 may indicate that the sequence of actions 75 and 76 may be executed in parallel to the sequence of actions 69, 71, and 73, and in parallel to action 66.

Reference is now made to FIG. 5, which is a simplified illustration of a plurality of cable devices 16 mounted on respective electric cables 78 of an electric grid 79, according to one exemplary embodiment.

As an option, the simplified illustration of FIG. 5 may be viewed in the context of the details of the previous FIGURES. Of course, however, the simplified illustration of FIG. 5 may be viewed in the context of any desired environment. Further, the aforementioned definitions may equally apply to the description below.

FIG. 5 shows a plurality of cable devices 16 mounted in various different places of electric grid 79. Particularly, cable devices 16 may be mounted on cables 78 of electric grid 79. A cable device 16 may be mounted on a cable 78 in mid cable, and is typically ungrounded. As shown in FIG. 5, cables 78 may be supported by poles, via insulators. FIG. 5 shows cables 78 between the poles or insulators. As shown in FIG. 5, a plurality of cable devices 16 may mounted in various different places of each of cables 78 of electric grid 79.

Alternatively, a cable device 16 may be mounted a particular place of a cable 78 of electric grid 79 and also measure phenomenon on other, parallel, cable 78 of electric grid 79 in co-located places.

As shown in FIG. 5, cable devices 16 may be electrically coupled to their respective cables 78, but are not connected to any other reference point such as ground, zero voltage line, common line, neutral line, etc.

In this respect, cable devices 16 may derive their operation energy, or electric power, from their respective cable devices 16, particularly, from the electric field, and/or from the magnetic field surrounding the electric cable 78 and produced by the electric voltage carried by the electric cable 78, and/or the electric current carried by the electric cable 78 (as will be further explained below).

In this respect, cable devices 16 may measure the electric current flowing via the respective electric cable 78, and/or electric voltage carried by the respective electric cable 78, by measuring the magnetic field, and the electric field, respectively. In this respect the voltage measuring system is an ungrounded voltage measuring system. It is appreciated that cable devices 16 may measure other physical phenomena such as temperature, humidity, wind, wind direction, location (e.g., by a GPS receiver), cable depression and angle, cable motion, etc.

Cable devices 16 may communicate between themselves as shown by arrow 80, and/or with local controller 81 as shown by arrow 82, and/or with local server 83 as shown by arrow 84.

Reference is now made to FIG. 6, which is a simplified illustration of cable device 16, mounted on cable 78 showing slot 85 for inserting cable 78 into cable device 16.

As an option, the simplified electric diagram of FIG. 6 may be viewed in the context of the details of the previous FIGURES. Of course, however, the simplified electric diagram of FIG. 6 may be viewed in the context of any desired environment. Further, the aforementioned definitions may equally apply to the description below.

Each of the cable devices 16 may include a slot 85 or a similar arrangement through which cable 78 may be inserted into cable devices 16 when mounting cable devices 16 on a live cable 78.

Each of the cable devices 16 may also include an irradiation sensor 86 or a similar arrangement for measuring the sun's irradiation value.

Reference is now made to FIG. 7, which is a simplified illustration of a cut through cable device 16 mounted on an electric cable 78, according to one exemplary embodiment.

As an option, the illustration of cable device 16 of FIG. 7 may be viewed in the context of the details of the previous FIGURES. Of course, however, the illustration of cable device 16 of FIG. 7 may be viewed in the context of any desired environment. Further, the aforementioned definitions may equally apply to the description below.

As shown in FIG. 7, the cable device 16 may include a box, or a body 87, through which the electric cable 78 passes. The electric cable 78 may be a part of an electric grid, an electric transmission network, or an electric distribution network, such as maintained by a power utility to provide electricity to the public, to industrial plants, etc. The cable device 16 may therefore be mounted on a live cable 78. That is, when cable 78 is fully powered and/or carries electric voltage and/or electric current.

The box 87 may be constructed of two parts which may be opened, and then closed around the cable 78. Alternatively, box 87 may be constructed of one part surrounding most of the cable diameter and having an opening at one side, such as slot 85 (not shown in FIG. 7), to insert cable 78 and attach the box to cable 78. Other constructions and shapes of box 87 are contemplated.

As shown in FIG. 7, the cable device 16 may include a power supply module 88, a controller module 89, one or more electric measuring devices 90, one or more physical measuring devices 91, and a backhaul communication module 92. Optionally, the cable device 16 may also include a local area communication module 93, a remote sensing module 94, and a propulsion control module 95. Optionally, the cable device 16 may also include cable clamping part 96, and a GPS module 97.

The GPS module 97 may serve here as an accurate time source. The time source of the cable device 16 may be any type of time source providing accuracy of 50 nanoseconds or better. The GPS module 97 is expected to provide time accuracy of 10 nanoseconds or better. Optionally, GPS module 97 may also provide an accurate universal clock, for example, for accurately determining absolute time of measurement. In this regard, the GPS signal serves as an accurate common time for all the cable devices 16, so that all the clocks of all the cable devices 16 are synchronized to the accuracy of the GPS signal. Optionally, cable device 16 may also include a global positioning service (GPS) module 97 and may use it to measure, monitor, and/or control the position of the cable device 16 along electric cable 78.

Electric measuring devices 90 may include one or more voltage measuring devices 98 and/or current measuring devices 99. Electric measuring devices 90 may include one or more irradiation measuring devices 100 (such as irradiation sensor 86 of FIG. 6). For example, irradiation measuring devices 100 may be adapted to the light band(s) in which the photovoltaic cells operate.

As shown in FIG. 7, the cable device 16 may include a magnetic core 101 over which at least one coil is wrapped to form a winding 102. The magnetic core 101 may be mounted around the electric cable 78. The magnetic core 101 may be constructed from two parts, a part in each of the two parts of box 87 where the two parts of the magnetic core 101 are closed around electric cable 78 when box 87 is attached to electric cable 78. However, optionally, and particularly for a high voltage cable, magnetic core 101 may be open in the sense that it has a slot though which electric cable 78 may be inserted.

The magnetic core 101 typically derives magnetic field from the electric current flowing in the electric cable 78. Winding 102 may derives electric current from the magnetic flux in the magnetic core 101. Winding 102 may be electrically coupled to power supply module 88, typically providing electric voltage to other modules of cable device 101. It is appreciated that cable device 16 may derive electric power from a single electric cable 78.

Alternatively or optionally, cable device 16 may derive electric power from a single electric cable 78 from the electric field of a high-voltage grid, for example, even when the electric cable 78 dose not carry current.

Alternatively, for example when used with insulated high-voltage cables, and/or underground cables and/or low-voltage grids, power supply module 88 may be connected to sensors attached to electric cables deriving power supply from other sources such as a main unit connected to a low voltage output of a transformer, a battery, a photovoltaic (PV) element, etc., Such configuration of cable device 16 may have only one part with an opening at the bottom.

Backhaul communication module 92 and local area communication module 93 may be coupled, each and/or both, to one or more antennas 103. Remote sensing module 94 may be coupled to and control various sensors, one or more cameras 104, one or more microphones 105, etc. It is appreciated that a camera can be mounted on a system of axels providing three-dimensional rotation. Alternatively, a plurality, or an array, of fixed cameras can be mounted to cover a large field of view as needed.

At least one camera 104 may provide an image of at least a part of the sky. Controller module 89 may process the sky image to produce cloud parameters such as cloud position, cloud area, speed of motion of the cloud, and direction of motion of the cloud. Such cloud parameters may be computed for each cloud within the sky image. Cloud parameters may be communicated to grid analysis system 20, which may compute more accurate cloud parameters, including cloud height, based on triangulation of at least three cable devices 16, which GPS data is known.

Backhaul communication module 92 and local area communication module 93 may use any type of communication technology and/or communication network such as, but not limited to: The terms ‘communication technology’, or ‘communication network’, or simply ‘network’ refer to any type of communication medium, including but not limited to, a fixed (wire, cable) network, a wireless network, and/or a satellite network, a wide area network (WAN) fixed or wireless, including various types of cellular networks, a local area network (LAN) fixed or wireless including Wi-Fi, and a personal area network (PAN) fixes or wireless including Bluetooth, ZigBee, and NFC, power line carrier (PLC) communication technology, etc. The terms ‘communication network’, or ‘network’ may refer to any number of networks and any combination of networks and/or communication technologies.

Controller module 89 may include a processor unit, one or more memory units (e.g., random access memory (RAM), a non-volatile memory such as a Flash memory, etc.), one or more storage units (e.g. including a hard disk drive and/or a removable storage drive, etc.) as may be used to store and/or to execute a software program and associated data and to communicate with external devices.

Propulsion control module 95 may be coupled to one or more actuating devices such as electric motor 106, which may be coupled to one or more wheels 107. Wheels 107 may be mounted on cable 78 to enable propulsion control module 95 to move the cable device 16 along cable 78 by controlling the electric motor 106.

It is appreciated that the propulsion system of cable device 16 (including, but not limited to propulsion control module 95, one or more electric motors 106 one or more wheels 107 etc.) may be operative to move cable device 16 along cable 78 and/or to rotate cable device 16 around cable 78.

It is appreciated that electric motor 106 represents herein any type of technology adequate to maneuver cable device 16 along and/or around cable 78, including, but not limited to, an AC motor, a DC motor, a stepper motor, a pneumatic pump and/or motor, a hydraulic pump and/or motor, or any other type of actuator.

Grid analysis system 20 may use the propulsion system and the GPS system of cable device 16 to distribute and position the cable devices 16 within the area serviced by the local grid to provide irradiation measurements around the respective photovoltaic electric generation units 15. As cable devices 16 may be positioned to provide sunlight and shadow irradiation measurements, grid analysis system 20 may redistribute cable devices 16 according to the changing location of the clouds, the associated shadow map, and the direction of motion of the clouds and/or their respective shadows.

Cable clamping part 96 may include, for example, a cable holder part 108 that may be pressed to cable 78 to firmly attach cable device 16 to cable 78. Cable holder part 108 may be maneuvered (e.g., up and down) by electrical means and/or by mechanical means such as a threaded rod 109. Threaded rod 109 may be operated by an electric actuator, or, by a shaft 110 inserted into a socket of cable attachment actuator part. Alternatively, Threaded rod 109 may be operated by a rod inserted into socket 111.

Reference is now made to FIG. 8, which is a simplified block diagram of a computational device 112, according to one exemplary embodiment.

As an option, the block diagram of FIG. 8 may be viewed in the context of the details of the previous FIGURES. Of course, however, the block diagram of FIG. 8 may be viewed in the context of any desired environment. Further, the aforementioned definitions may equally apply to the description below. Particularly, the computational device 112 of FIG. 8, may correspond to, or may be included within, for example, cable device 16, local controller 81, server 83, grid management system 19, grid analysis system 20, etc.

As shown in FIG. 8, computational device 112 may include at least one processor unit 113, one or more memory units 114 (e.g., random access memory (RAM), a non-volatile memory such as a Flash memory, etc.), one or more storage units 115 (e.g. including a hard disk drive and/or a removable storage drive, representing a floppy disk drive, a magnetic tape drive, a compact disk drive, a flash memory device, etc.).

Computational device 112 may also include one or more irradiation measurement units 116 such as such as irradiation sensor 86 of FIG. 6 and/or irradiation measurement unit 100 of FIG. 7.

Computational device 112 may also include one or more communication units 117. Such communication unit 117 may use any type of communication technology, particularly RF communication technology, particularly communication technology such as Wi-Fi, Bluetooth, ZigBee, and any remote-control communication technology as may be used by cable device 16 to communicate with any other cable device 16 or with a remote controller, a remote server, or any other computational device.

Computational device 112 may also include one or more communication buses 118 connecting the above units. Computational device 112 may also include one or more control circuitry 119 for controlling other devices coupled to, or included in, body 87.

Computational device 112 may also include one or more computer programs 120, or computer control logic algorithms, which may be stored in any of the memory units 114 and/or storage units 115. Such computer programs, when executed, enable computing system 112 to perform various functions as set forth herein. Memory units 114 and/or storage units 115 and/or any other storage are possible examples of tangible computer-readable media. Particularly, computer programs 120 may include a software program and collected data for computing the cable voltage with respect to the reference point.

It is appreciated that certain features, which are, for clarity, described in the context of separate embodiments, may also be provided in combination in a single embodiment. Conversely, various features, which are, for brevity, described in the context of a single embodiment, may also be provided separately or in any suitable sub-combination.

Although descriptions have been provided above in conjunction with specific embodiments thereof, it is evident that many alternatives, modifications, and variations will be apparent to those skilled in the art. Accordingly, it is intended to embrace all such alternatives, modifications and variations that fall within the spirit and broad scope of the appended claims. All publications, patents and patent applications mentioned in this specification are herein incorporated in their entirety by reference into the specification, to the same extent as if each individual publication, patent, or patent application was specifically and individually indicated to be incorporated herein by reference. In addition, citation, or identification of any reference in this application shall not be construed as an admission that such reference is available as prior art.

What is claimed is:

1. A computer-implemented method for mitigating fluctuations of power quality in an electric grid, the method comprising:
automatically collecting, by a local computer, electric production data comprising power capacity of an electric grid,
location of at least one photovoltaic electric generation unit connected to the electric grid, and
electric power generation by the at least one photovoltaic electric generation unit;
automatically receiving, by the local computer, from a computer of at least one weather station, a weather prediction comprising at least one of location, thickness, direction of motion, and speed of motion, of at least one cloud;
computing at least one of location, direction of motion, speed of motion, and irradiation for at least one cloud shadow;
computing at least one of cloud shadow impact and time of impact on the at least one photovoltaic electric generation unit;
performing, before the cloud shadow reaches the photovoltaic electric generation unit, at least one of:
reducing power generation capacity of the at least one photovoltaic electric generation unit;
increasing power input of at least one power-generating-unit;
providing electric power from an electric storage unit;
connecting capacitance to the grid;
disconnecting capacitance from the grid.
connecting inductance to the grid; and
disconnecting inductance from the grid.

2. The method according to claim 1, further comprising:
distributing a plurality of cable measuring devices, wherein each cable measuring device is mounted on a cable of said electric grid, wherein each of said cable measuring devices is capable of measuring at least one of: voltage of the cable, current through the cable, solar irradiation, wind direction, and wind speed;
receiving from at least one of the cable measuring devices the at least one measurement; and
computing at least one of location, direction of motion, speed of motion, and irradiation for at least one cloud shadow.

3. The method according to claim 1, wherein said impact is calculated according to at least one of: voltage quality, power quality, change of voltage quality, change of power quality, and a predetermined threshold value.

4. The method according to claim 1, further comprising at least one of:
the power transmission value comprises power quality value measured by at least one measuring device of the plurality of measuring devices;
the impact comprises power quality value measured by at least one measuring device of the plurality of measuring devices;
the power transmission value comprises voltage quality value measured by at least one measuring device of the plurality of measuring devices;
the impact comprises voltage quality value measured by at least one measuring device of the plurality of measuring devices; and
the voltage quality comprises anticipated deviation of voltage measurement value from a standard voltage value.

5. A computer-implemented method for mitigating fluctuations of power quality in an electric grid, the method comprising:
A. determining a configuration of a part of the electric grid, the configuration including at least one power generating unit, at least one power consumer, and the electric grid interconnecting between the at least one power-generating-unit and the at least one power-consumer;
B. distributing a plurality of measuring devices within the electric grid interconnecting between the at least one power generating unit power generating unit and the at least one power generating unit power consumer;
C. automatically and continuously collecting power input values for at least one power input, by the respective at least one power-generating-unit, into the part of the electric grid;
D. automatically and continuously collecting a plurality of power transmission values from the respective plurality of measuring devices;
E. automatically and continuously collecting weather forecasts for a predetermined future timeframe, the weather forecasts being applicative to respective at least one power generating unit providing respective power input into the part of the electric grid;
F. automatically and continuously determining anticipated effect of each weather forecast on each power input and each measuring device to determine at least one weather-affected power-generating-unit; and
G. if the anticipated effect exceeds a predetermined threshold perform at least one of:
reducing power generation capacity of the at least one photovoltaic electric generation unit;
increasing power input of at least one power-generating-unit;
providing electric power from an electric storage unit;
connecting capacitance to the grid;
disconnecting capacitance from the grid.
connecting inductance to the grid; and
disconnecting inductance from the grid.

6. A computer-implemented method for mitigating fluctuations of power quality in an electric grid, the method comprising:
distributing a plurality of cable measuring devices, wherein each cable measuring device is mounted on a cable of said electric grid, wherein each of said cable measuring devices is capable of measuring at least one of: voltage of the cable, current through the cable, solar irradiation, wind direction, and wind speed;
automatically collecting, by a local computer, electric production data comprising
power capacity of an electric grid,
location of at least one photovoltaic electric generation unit connected to the electric grid, and
electric power generation by the at least one photovoltaic electric generation unit;
receiving from at least one of the cable measuring devices the at least one measurement;
computing at least one of location, direction of motion, speed of motion, and irradiation for at least one cloud shadow;
computing at least one of cloud shadow impact and time of impact on the at least one photovoltaic electric generation unit;
performing, before the cloud shadow reaches the photovoltaic electric generation unit, at least one of:
reducing power generation capacity of the at least one photovoltaic electric generation unit;
increasing power input of at least one power-generating-unit;
providing electric power from an electric storage unit;
connecting capacitance to the grid;
disconnecting capacitance from the grid.
connecting inductance to the grid; and
disconnecting inductance from the grid.
